(19) United States
(12) Patent Application Publication
(10) Pub. No.: US 2025/0372316 A1
(43) Pub. Date: Dec. 4, 2025

(54) METHOD FOR FORMING A SUPERCAPACITOR

(71) Applicant: Arushi Singh, Fremont, CA (US)

(72) Inventor: Arushi Singh, Fremont, CA (US)

(21) Appl. No.: 18/676,711

(22) Filed: May 29, 2024

(51) Int. Cl. H01G 11/86; H01G 11/24; H01G 11/34; H01G 11/36

(52) U.S. Cl. CPC H01G 11/86; H01G 11/24; H01G 11/34; H01G 11/36

(57) ABSTRACT

The present disclosure discloses provides a method for forming a supercapacitor. The method includes the steps of applying dough of a predefined quantity on at least two conductive substrates. The method further includes creating cavities in the dough applied on the at least two conductive substrates at a first temperature range for a threshold time interval. Further, the method includes carbonizing the dough applied on the at least two conductive substrates at a second temperature range for a predetermined time at a predetermined heating rate, to form at least two electrodes. Carbonizing the dough applied on the at least two conductive substrates is performed in an oxygen deficient condition. Furthermore, the method includes forming the super capacitor by assembling the at least two electrodes in at least one electrolyte.

### TECHNICAL FIELD

The present disclosure relates to supercapacitors and more particularly relates to a method for forming a supercapacitor.

### BACKGROUND

Supercapacitors are a type of electrochemical energy storage system that exhibit high power density and specific capacitance and are capable of efficiently releasing energy over a relatively short time. Generally, the supercapacitors are used in applications with large power bursts, for example, regenerative breaking in high-speed trains.

However, the energy density of the existing supercapacitors is comparatively lower than the energy density of conventional energy storage systems (e.g., lithium-ion batteries). Due to the low energy density of the supercapacitors compared to the conventional energy storage systems, the supercapacitors are incapable of being used as the primary storage device in applications such as electric vehicles (EVs), batteries in electronics, etc. In addition, manufacturing of the conventional energy storage systems (e.g., lithium-ion batteries) involves high costs and significant challenges associated with mining lithium.

Further, there are several existing techniques to improve the energy density in the supercapacitor. Some existing techniques are the usage of binder materials, hybrid and composite materials, complex architecture design, integrating the existing supercapacitor with the conventional energy storage system, and the like. Implementing the existing techniques such as using advanced electrode materials or manufacturing processes, significantly increases the cost of supercapacitor production. Further, there is increased complexity with the implementation of complex architecture design (e.g., electrode architectures), thus it is challenging to scale up for mass production of the supercapacitors. Moreover, meeting regulatory requirements and standards for safety, performance, and environmental impact can pose additional challenges for supercapacitor technologies.

Therefore, there is a need for an improved method for forming a supercapacitor to overcome one or more limitations stated above, in addition to providing other technical advantages.

### SUMMARY

Various embodiments of the present disclosure provide a method for forming a supercapacitor.

In an embodiment, a method for forming a supercapacitor is disclosed. The method includes the steps of applying dough of a predefined quantity on at least two conductive substrates. The method includes creating cavities in the dough applied on the at least two conductive substrates by heating the dough at a first temperature range for a threshold time interval. Further, the method includes carbonizing the dough applied on the at least two conductive substrates at a second temperature range for a predetermined time at a predetermined heating rate, to obtain at least two electrodes. Carbonizing the dough applied on the at least two conductive substrates is performed in an oxygen deficient condition. Furthermore, the method includes forming the supercapacitor by assembling the at least two electrodes in at least one electrolyte.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates a schematic view of a supercapacitor, in accordance with an embodiment of the present disclosure;

FIG. 2 illustrates a flowchart of a method for forming a supercapacitor, in accordance with an embodiment of the present disclosure; and

FIG. 3 illustrates a schematic view of a supercapacitor, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or conjunction with each other, one skilled in the art will appreciate that many of these features can be provided independently of other features. Accordingly, this description of the present disclosure is set forth without any loss of generality to, and without imposing limitations upon, the present disclosure.

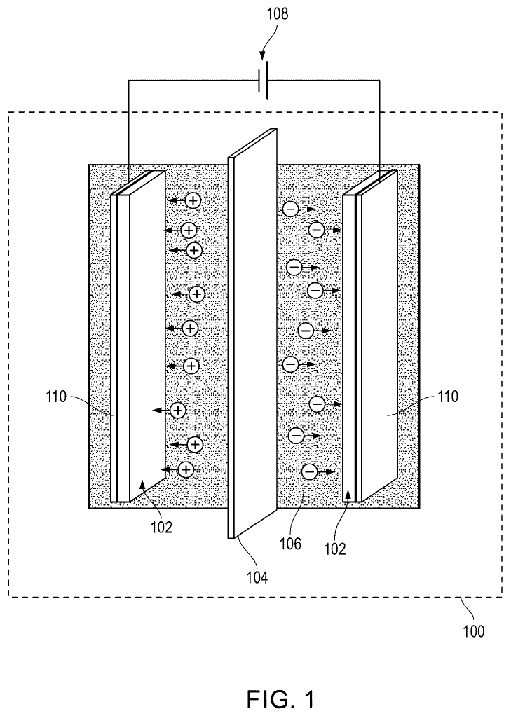

Various embodiments of the present disclosure are described with reference to FIG. 1 to FIG. 3.

FIG. 1 illustrates a schematic view of a supercapacitor 100, in accordance with an embodiment of the present disclosure. As shown, the supercapacitor 100 includes electrodes 102, at least one electrolyte 106, and a separator film 104. As shown, the supercapacitor 100 includes two electrodes 102. It is to be noted that the electrodes 102 may include a positive electrode (anode) and a negative electrode (cathode). The electrodes 102 are conductive materials that are configured to store electrical charge during the charging process. In other words, the electrodes 102 facilitate electron transfer in the supercapacitor 100. Further, the electrodes 102 are assembled in the electrolyte 106 and the separator film 104 is inserted between the electrodes 102. This type of supercapacitor configuration shown in FIG. 1 corresponds to a single-cell configuration. Alternatively, the supercapacitor 100 may include other configurations such as, but not limited to, multi-cell configuration, stacked configuration, symmetric configuration, asymmetric configuration, and integrated configuration. It is to be noted that the structural configuration of the supercapacitor 100 may be selected based on factors such as energy storage requirements, power requirements, voltage levels, and size constraints.

Further, the electrolyte 106 is a conductive solution or material that provides the medium for ion transport between the electrodes 102 during charge and discharge cycles. The electrolyte 106 may include, but not limited to, sodium hydroxide (NaOH), potassium hydroxide (KOH), hydrochloric acid (HCl), nitric acid (HNO₃), sulphuric acid (H₂SO₄) and potassium sulphate K₂SO₄). The concentration of the electrolyte 106 may range from IM to 10 M. Furthermore, the separator film 104 is a thin and porous membrane that separates the positive and negative electrodes (i.e., the electrodes 102) to prevent electrical short circuits while allowing the flow of ions between the electrodes 102. The separator film 104 may include at least cellulose-based separators.

In one embodiment, gel polymer electrolytes may be used as the electrolyte 106 in the supercapacitor 100. In this scenario, the separator film 104 may not be required between the electrodes 102. Some non-limiting examples of the polymer used in the gel polymer electrolytes may include polyvinyl alcohol (PVA), polyethyleneoxide (PEO), polyvinylidene difluoride (PVdF), polyvinyl chloride (PVC), polymethyl methacrylate (PMMA) and poly-vinylidene fluoride-hexafluoropropylene (P(VDF-HFP)) copolymer, and the like. The polymer is combined with a strong base, acid, or salt solution to create the gel polymer electrolyte.

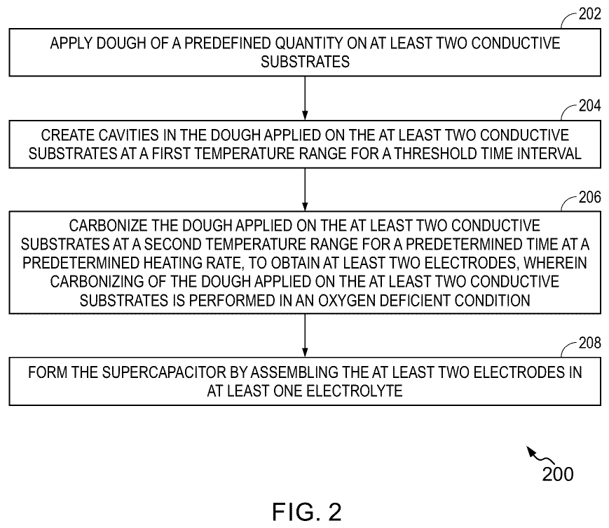

In an embodiment, the electrodes 102 may be connected to an external power source (see, 108) using a conductive interface for allowing the flow of electrical current during charge cycles. The electrodes 102 are formed from the carbonization of dough applied to substrates 110. The electrodes 102 formed upon carbonization may be of opposite polarities (positive and negative electrodes) as explained above. The formation of the electrodes 102 of the supercapacitor 100 is explained in detail with reference to FIG. 2.

FIG. 2 is an exemplary embodiment of the present disclosure illustrating a flowchart depicting a method 200 for forming a supercapacitor such as the supercapacitor 100. The method is now described with reference to the flowchart blocks and is as below. The order in which the method is described is not intended to be construed as a limitation, and any number of the described method blocks can be combined in any order to implement the method. Additionally, individual blocks may be deleted from the methods without departing from the scope of the subject matter described herein.

The various processing steps for forming the supercapacitor are described below:

At 202, the method 200 includes applying the dough of a predefined quantity on at least two conductive substrates (see, 110 of FIG. 1). The conductive substrates 110 may include, but are not limited to, graphite paper, metal foil, and metal mesh. The conductive substrates 110 may be configured with a thickness of about 25 micrometers (um) to 250 micrometers (μm). In an embodiment, the thickness of the conductive substrates 110 may be in the range of 10 μm to 500 μm as per the design feasibility and requirements. In one example scenario, the conductive substrates 110 may include metal materials as explained above. In this scenario, metal elements of the conductive substrates 110 are to be selected that are unreactive with the electrolyte 106 of the supercapacitor 100.

Further, the dough of the predefined quantity is applied on each of the conductive substrates 110 (e.g., on one side of the conductive substrates 110). In one example scenario, the dough may be formed by mixing flour and water in a predefined ratio by weight. The flour used in the dough may be selected from grains including wheat, rice, bulgur, rye, barley, corn, oats, teff, millet, and quinoa. Further, the dough may be made from damaged grain materials or grains that are not fit for human or animal consumption. The damaged grain materials may be obtained due to mold, mildew, or other parasite and/or water damage. Furthermore, additives such as grain husk and other waste food materials may be used to form the dough. The additives may be mixed in a specific proportion of about 20% by mass of the dough. The additives may reduce the amount of grain required.

In one case, the predefined ratio by weight of the mixture of flour and water may be equivalent to a first predefined ratio of about 3:2. The first predefined ratio 3:2 of flour and water may correspond to a nominal ratio (or a nominal consistency) to form a dough (i.e., the dough) that is used for general applications (e.g., making bread). In another case, the predefined ratio of flour and water may be equivalent to one of a second predefined ratio of about 4:1 and a third predefined ratio of about 2:3. The second predefined ratio of about 4:1 and the third predefined ratio of about 2:3 of mixing flour and water may correspond to a lower limit and an upper limit of mixing flour and water to form the dough.

In another example scenario, the dough may be prepared by mixing flour with at least one of water and brine (saturated salt solution).

After forming the dough, the dough is applied onto the conductive substrates 110. The dough may be applied onto the conductive substrates using a pressing apparatus (e.g., a sheeter press). The dough may be placed on each of the conductive substrates 110 and then cycled through the sheeter press until a thin layer of the dough covers the conductive substrates 110. Further, binder materials may not be needed to make the dough adhere to a surface of the conductive substrates 110, thereby providing a method for forming supercapacitors from natural ingredients.

At 204, the method 200 includes creating cavities in the dough applied on the conductive substrates 110 by heating the doughat a first temperature range for a threshold time interval. In an embodiment, the cavities (e.g., microcavities) in the dough are created by proofing the dough applied on the at least two conductive substrates 110 at the first temperature range for the threshold time interval. The first temperature range is about 20 degrees Celsius (° C.) to 30 degrees Celsius (° C.). The threshold time interval is about 30 minutes to 3 hours. The threshold time interval may be determined based at least on a quantity of at least one catalyst used for proofing the dough applied on the electrodes 102. For example, the catalyst may include, but not limited to, yeast and baking powder. The catalyst used for proofing the dough rapidly increases bubble or cavity formation in the dough. The cavity or bubble formation in the dough increases the surface area of the dough applied onto the conductive substrates 110. In an embodiment, the proofing time (or the threshold time interval) may be adjusted from 30 minutes to 24 hours based on the manufacturing requirements.

In another embodiment, the dough applied on the conductive substrates 110 may be frozen for a predefined time to allow the formation of ice crystals in the dough. In this scenario, the predefined time of freezing the dough may be in the range of 5 minutes to 24 hours. Further, the formation of ice crystals in the dough creates pores and cavities of a size ranging from 50 nm to 1000 nm. This results in creating additional surface area within the dough being applied on the conductive substrates 110.

In another embodiment, the dough formed using flour and brine may be subjected to evaporation to increase the surface area of the dough applied on the conductive substrates. In particular, salt crystals from the dough are obtained by evaporation of water in the dough. The salt crystals form pores or cavities in the dough which is explained further in detail.

At 206, the method 200 includes carbonizing the dough applied on the at least two conductive substrates 110 at a second temperature range for a predetermined time at a predetermined heating rate, to obtain at least two electrodes 102. For instance, carbonizing the proofed dough applied on the at least two conductive substrates 110 may be performed in an oxygen-deficient condition (or oxygen free environment). The second temperature range is about 600° C. to 1300° C. The predetermined time ranges from 30 minutes to 2 hours. Further, the predetermined heating rate is between 5° C./min and 15° C./min. In an embodiment, carbonizing may be performed in a furnace (e.g., a smelter furnace). In an embodiment, the capacitance of the carbonized electrode may range from 1.75-3.0 F/cm² for a 10 mg mass of the carbonized electrode, i.e. 175-300 F/g.

In the case of the dough formed using flour and brine, the salt crystals form inside the dough upon evaporation of water in the dough. After carbonization of the dough, the salt crystals embedded in the carbonized electrodes 102 are dissolved in at least one of the water, acidic, or basic solutions. This results in the formation of pores and/or cavities in the dough applied on the conductive substrates 110 (or the electrodes 102). To that effect, the surface area of the dough applied on the at least two conductive substrates 110 increases. In other words, the dissolution of the microcrystals (i.e., the salt crystals) after the carbonization process creates pores in the carbonized electrodes 102 thus increasing the surface area in the carbonized electrodes 102.

Additionally, the dough may be mixed with a specific quantity (e.g., up to 40% by mass) of one of carbon nanotubes (CNT) and activated carbon. Thereafter, the mixture of the dough and CNT or activated carbon is applied onto the conductive substrates 110. It is to be noted that the addition of the carbon nanotubes (CNT) or the activated carbon to the dough increases the surface area of the dough upon carbonization. It should be noted that high surface area fillers may be added easily to the electrodes 102 (through addition to dough prior to carbonization) due to the absence of the formation of complex binders from the dough.

At 208, the method 200 includes forming the supercapacitor by assembling the at least two electrodes 102 in the at least one electrolyte 106. Additionally, the separator film 104 is introduced between the electrodes 102 (as shown in FIG. 1). Further, in the case of using gel polymer electrolytes as the electrolyte 106, the separator film 104 may not used in the supercapacitor 100. For example, the separator film 104 may include commercially available polyethylene or polypropylene films with pores of about 100-500 nm. Additionally, thin paper or porous glass fiber films can be used as the separator film 104.

Further, the supercapacitor 100 may include an exemplary specification of 300 F/g capacitance that corresponds to approximately 14 Wh/kg energy density for the supercapacitor at 1V operating voltage (assuming cell mass is 3 times the electrode mass) and 191 Wh/kg at 3.7V operating voltage.

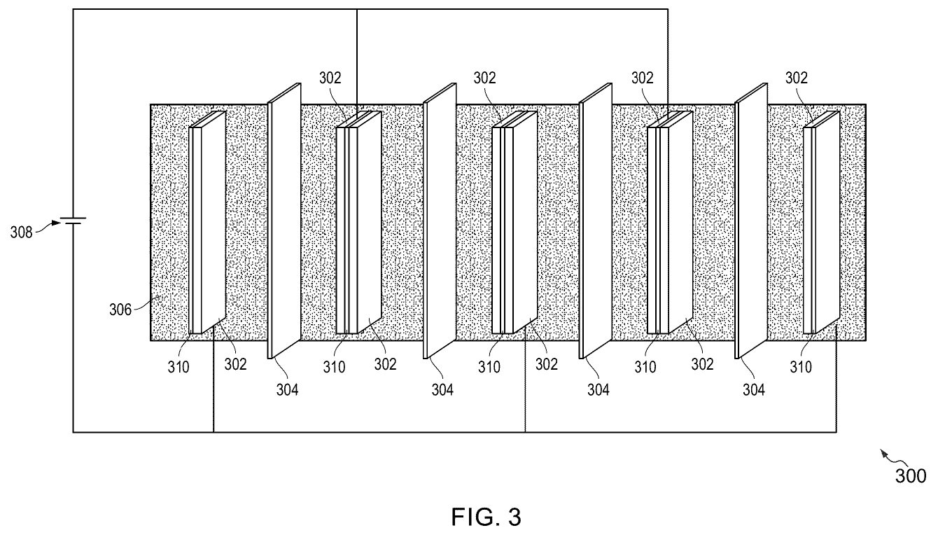

FIG. 3 illustrates a schematic view of a supercapacitor 300, in accordance with an embodiment of the present disclosure. As shown, the supercapacitor 300 includes electrodes 302, a separator film 304, and at least one electrolyte 306. It is to be noted that the electrodes 302 may include a positive electrode (anode) and a negative electrode (cathode) that are connected in parallel configuration with a power source (see, 308). The electrodes 302 facilitate the electron transfer in the super capacitor 300. Further, the separator film 304 is disposed between two electrodes (i.e., the electrodes 302) of the supercapacitor 300. Further, the electrodes 302 and the separator film 304 are assembled in the electrolyte 306 to form the supercapacitor 300.

Further, the electrodes 302 are formed from the carbonization of dough applied to the conductive substrates 310. The dough may be applied to either one side or both sides of the conductive substrates 310 to form electrodes 302 as a result of the carbonization of the dough (as shown in FIG. 3). It should be noted that the functionality and method of forming the electrodes 302 in the supercapacitor 300 are similar to the functionality and the method of forming the supercapacitor 100 as explained with reference to FIGS. 1 and 2. Hence, the method of forming the supercapacitor 300 and its functionality are not explained in detail for the sake of brevity.

One or more of the advantages of the present disclosure may include that the electrodes in the supercapacitor exhibit high capacitance and high surface area. To that effect, the supercapacitor is provided with improved energy density. Further, the present disclosure provides a cost-efficient method for forming the supercapacitor electrodes using organic materials. Hence, there is a significant reduction in environmental pollution. Furthermore, the method of forming the supercapacitor as disclosed in the present disclosure eliminates/mitigates the usage of binder materials.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for forming a supercapacitor, comprising:
applying dough of a predefined quantity on at least two conductive substrates;
creating cavities in the dough applied on the at least two conductive substrates by heating the dough at a first temperature range for a threshold time interval; and
carbonizing the dough applied on the at least two conductive substrates at a second temperature range for a predetermined time at a predetermined heating rate, to obtain at least two electrodes, wherein carbonizing of the dough applied on the at least two conductive substrates is performed in an oxygen deficient condition; and
forming the supercapacitor by assembling the at least two electrodes in at least one electrolyte.

2. The method as claimed in claim 1, wherein the cavities in the dough are created by proofing the dough applied on the at least two conductive substrates at the first temperature range for the threshold time interval, and wherein the first temperature range is about 20 degrees Celsius (° C.) to 30 degrees Celsius (° C.), and the threshold time interval is about 30 minutes to 3 hours.

3. The method as claimed in claim 1, wherein the threshold time interval is determined based at least on a quantity of at least one catalyst used for proofing the dough applied on the at least two conductive substrates.

4. The method as claimed in claim 3, wherein the at least one catalyst comprises yeast and baking powder.

5. The method as claimed in claim 1, wherein the second temperature range is about 600° C. to 1300° C., and the predetermined time ranges from 30 minutes to 2 hours.

6. The method as claimed in claim 1, wherein the predetermined heating rate is about 5° C./min to 15° C./min.

7. The method as claimed in claim 1, wherein the conductive substrate comprises at least one of graphite paper, metal foil, and metal mesh.

8. The method as claimed in claim 1, wherein the thickness of the conductive substrate ranges from 25 μm to 250 μm.

9. The method as claimed in claim 1, further comprising freezing the dough applied on the at least two conductive substrates for a predefined time to allow the formation of ice crystals in the dough.

10. The method as claimed in claim 9, wherein the formation of ice crystals in the dough creates cavities in the dough of a size ranging from 50 nm to 1000 nm.

11. The method as claimed in claim 9, wherein the predefined time of freezing ranges from 5 minutes to 24 hours.

12. The method as claimed in claim 1, wherein the dough comprises a mixture of flour and water in a predefined ratio by weight.

13. The method as claimed in claim 12, wherein the predefined ratio by weight of the mixture of flour and water comprises at least one of a first predefined ratio of about 3:2, a second predefined ratio of about 4:1, and a third predefined ratio of about 2:3.

14. The method as claimed in claim 1, wherein the dough comprises a mixture of flour with at least one of water and brine solution.

15. The method as claimed in claim 14, further comprising:
creating salt crystals in the dough by evaporation of water in the dough;
carbonization of the dough applied onto the at least two conductive substrates to form the at least two electrodes; and
dissolving the salt crystals in at least one of water, acidic solution, and basic solution, thus resulting in the formation of pores and cavities in the at least two electrodes.

16. The method as claimed in claim 1, wherein the dough is mixed with a specific quantity of about 40% by mass of one of carbon nanotubes (CNT) and activated carbon, wherein the addition of one of the carbon nanotubes (CNT) and the activated carbon to the dough increases a surface area of the dough.

17. The method as claimed in claim 1, further comprising forming the supercapacitor by inserting a separator film between the at least two electrodes immersed in the at least one electrolyte.

18. The method as claimed in claim 1, wherein the at least one electrolyte comprises at least one of sodium hydroxide (NaOH), potassium hydroxide (KOH), hydrochloric acid (HCl), nitric acid (HNO₃), sulphuric acid (H₂SO₄), potassium sulphate K₂SO₄), and gel polymer electrolytes, the gel polymer electrolytes comprising polyvinyl alcohol (PVA), polyethylene oxide (PEO), polyvinylidene difluoride (PVdF), polyvinyl chloride (PVC), polymethyl methacrylate (PMMA) and poly-vinylidene fluoride-hexafluoropropylene (P(VDF-HFP)) copolymer.

19. The method as claimed in claim 1, wherein the dough is formed using at least wheat, rice, bulgur, rye, barley, corn, oats, teff, millet, quinoa, and damaged grain materials obtained due to mold, mildew, parasites, and water damage.

20. The method as claimed in claim 1, wherein the dough further comprises additives of about 20% by mass of the dough, the additives comprising at least grain husk, and waste food materials.
